(19) United States
(12) Patent Application Publication
(10) Pub. No.: US 2008/0087594 A1
(43) Pub. Date: Apr. 17, 2008

(54) Chamber Filter Plate and Filter Plate Configuration

(75) Inventors: Manfred Hermann, Nurnberg (DE); Bernhard Salbaum, Muhlstetten (DE)

Correspondence Address: LERNER GREENBERG STEMER LLP, P O BOX 2480, HOLLYWOOD, FL, 33022-2480, US

(73) Assignee: JVK FILTRATION SYSTEMS GMBH, Georgensgmund (DE)

(21) Appl. No.: 11/875,990

(22) Filed: Oct. 22, 2007

Related U.S. Application Data
(63) Continuation of application No. PCT/EP2006/003614, filed on Apr. 20, 2006.

(30) Foreign Application Priority Data
Apr. 20, 2005 (DE) DE202005006286.3

(51) Int. Cl. B01D 25/164

(52) U.S. Cl. 210/230

(57) ABSTRACT

A chamber filter plate for a filter press includes a plate edge which is thicker than a plate surface and surrounds the same. The plate surface has at least one slurry feed borehole. A supporting ring surrounds the edge of the slurry feed borehole. A mounting flange of the supporting ring is coplanar with the plate surface. A projecting element projects from the assembly flange. A filter plate configuration with at least two chamber filter plates, is also provided.

### CROSS-REFERENCE TO RELATED APPLICATIONS

This is a continuing application, under 35 U.S.C. § 120, of copending International Application No. PCT/EP2006/003614, filed Apr. 20, 2006, which designated the United States; this application also claims the priority, under 35 U.S.C. § 119, of German Patent Application DE 20 2005 006 286.3, filed Apr. 20, 2005; the prior applications are herewith incorporated by reference in their entirety.

### BACKGROUND OF THE INVENTION

Field of the Invention

The invention relates to a chamber filter plate for a filter press. Such chamber filter plates include a plate body and a plate edge that is thicker than the plate surface of the plate body and surrounds the same. The plate edge is thicker than the plate body, so that a recessed area is formed within the plate edge. When two or more chamber filter plates are stacked side by side, their edges rest against one another, forming filter chambers between the edges. The invention also relates to a filter plate configuration having at least two chamber filter plates.

At least one slurry feed opening is provided in the plate body in order to introduce the slurry into the filter chambers for filtering. The slurry feed opening usually has a support ring encircling its edge.

The chamber filter plates which are disposed side by side to form a filter packet lie with their edge areas adjacent one another, so that they are supported against one another. The plate bodies that lie inside the plate edges do not have that type of adjacent support. The danger therefore exists that the plate bodies will become deformed in an undesirable manner as a result of high filter pressures. It is known to provide support elements in the region of the plate bodies in order to reduce the deformation of the plate bodies within a filter packet made up of multiple chamber filter plates. Those are cam-type support elements, which usually project beyond the plate surface of the plate body, and rest against one another when the filter packet is closed. A deformation of the filter plate in the region of the slurry feed opening is particularly undesirable.

European Patent Application EP 0 579 103 A describes a support structure for a filter press plate. That support structure includes a support ring in the region of a slurry feed borehole, which has a mounting flange and six projecting elements that project out of the mounting flange. Each of those projecting elements has a countersunk hole configured to accommodate a slotted screw with a countersunk head. Those screws serve to clamp the mounting flange with a ring disposed on the rear side of the borehole.

### BRIEF SUMMARY OF THE INVENTION

It is accordingly an object of the invention to provide a chamber filter plate and a filter plate configuration, which overcome the hereinafore-mentioned disadvantages of the heretofore-known devices of this general type and which improve the stability of the chamber filter plate in the region of the slurry feed opening.

With the foregoing and other objects in view there is provided, in accordance with the invention, a chamber filter plate for a filter press. The chamber filter plate comprises a plate surface having at least one slurry feed borehole formed therein defining an edge of the slurry feed borehole. A plate edge is thicker than and extends around the plate surface. A support ring encompasses the edge of the slurry feed borehole. A mounting flange is disposed on the support ring, coplanar with the plate surface. At least three mounting cap screws are distributed at equal angles, such as 120°, about the mounting flange, extend through the mounting flange and fasten the support ring to the plate surface. The at least three mounting cap screws each include a screw head acting as a projecting element having an end surface facing away from the plate surface with a flat area configured to be coplanar with a plate surface of an adjacent chamber filter plate.

The chamber filter plate of the invention therefore has a support ring in the region of the slurry feed opening, with a mounting flange that extends at the same level as the plate surface and is molded on to the plate surface when mounted. At least one projecting element projects outward from the mounting flange. This projecting element is supported against the support ring of the respective adjacent filter plate when the filter packet is assembled.

It is advantageous for the projecting element to have a flat area that extends coplanar to the plate surface because this will ensure that a large area of the projecting element will rest against the adjacent support ring. In this manner, the support ring is able to withstand the support forces acting on it and to transfer them to the adjacent support ring. A three-point support with three projecting elements, each spaced 120° around the mounting flange, is particularly advantageous because of the even pressure distribution this creates. This configuration can be doubled to a six-point support, with the projecting elements spaced 60° apart.

It is particularly advantageous for the support ring to be fastened to the plate surface with one or advantageously several mounting screws. The mounting screws in this case are configured as cap or head screws. In this configuration, the cap screws fulfill a dual function, namely the fastening function of the mounting screws and the support function of the projecting elements. Since the mounting screws are detachably fastened to the chamber filter plate, mounting screws having various heights of the screw heads can also be used. Thus, the screw having the optimal screw head height can always be used to adapt to the respective filter chamber. It is also possible to use the mounting flange and the mounting screws to fasten a filter cloth in the region of the support ring, and to seal it at the same time. Since the adjacent chamber filter plates are also supported by the screw heads, a slit having a constant thickness is created between each of the adjacent chamber filter plates in the region of the slurry feed opening.

In accordance with another feature of the invention, the width of the mounting flange is adjusted to the diameter of the screw heads.

In accordance with a further feature of the invention, by using a metal support ring, especially a steel ring, the chamber filter plate is also suited for pressing at high temperatures and high differential pressures. It is also possible to filter and press out chemically aggressive suspensions using metal rings. The metal support ring materials are particularly preferable due to their chemical stability.

In accordance with an added feature of the invention, a placement of the slurry feed opening at the center of the plate surface is especially advantageous due to an even distribution of the filtrate to be fed in. It is also possible to operate a so-called membrane filter press with the invention. With a membrane filter press of this type, every second chamber filter plate is additionally equipped with a membrane, which ejects the filter cake when the filter chambers are emptied.

With the objects of the invention in view, there is also provided a filter plate configuration, comprising at least two mutually adjacent chamber filter plates according to the invention. The screw heads, acting as projecting elements, rest against the support ring of a respective adjacent chamber filter plate, for supporting the support rings against one another.

In accordance with a concomitant feature of the invention, a membrane is disposed on one of the chamber filter plates forming a membrane filter plate. The membrane filter plate alternates side by side with a chamber filter plate without a membrane.

Other features which are considered as characteristic for the invention are set forth in the appended claims, noting that the dependent claims relate to further improvements of the invention that are in part advantageous and in part inventive in their own right.

Although the invention is illustrated and described herein as embodied in a chamber filter plate and a filter plate configuration it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a chamber filter plate according to the invention;

FIG. 2 is an enlarged, fragmentary, perspective view of a slurry feed opening in the chamber filter plate of FIG. 1;

FIG. 3 is a perspective view of a mounting screw according to the invention; and

FIG. 4 is a sectional view of a filter plate configuration with a chamber filter plate and a membrane filter plate.

### DETAILED DESCRIPTION OF THE INVENTION

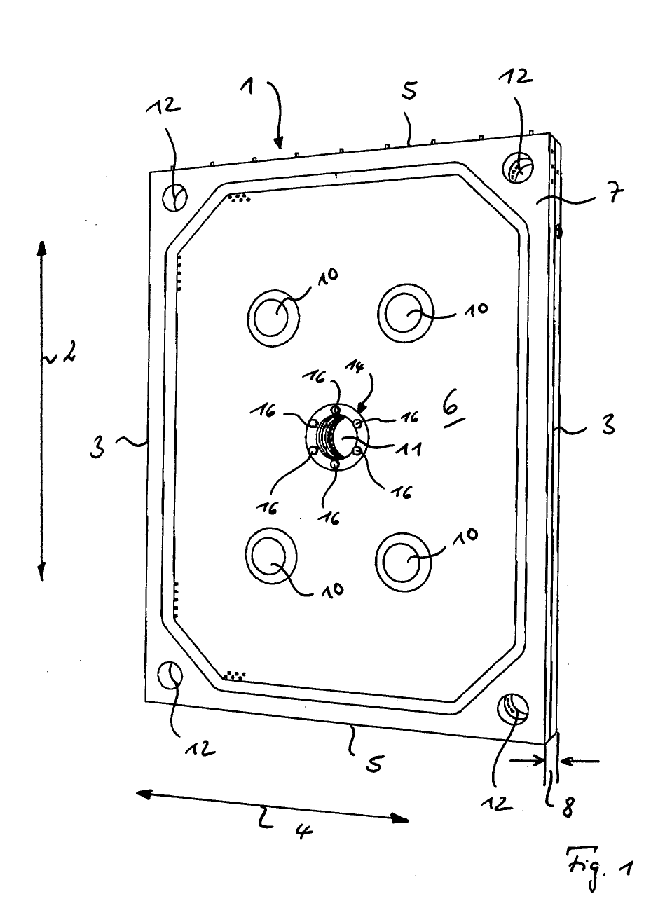

Referring now to the figures of the drawings in detail and first, particularly, to FIG. 1 thereof, there is seen a rectangular chamber filter plate 1 which has two parallel lengthwise sides 3 that extend in a longitudinal direction 2, and two parallel crosswise sides 5 that extend in a crosswise direction 4 at right angles to the lengthwise sides 3. A plate body of the chamber filter plate 1 is made up of a plate surface 6 and a plate edge 7 that borders the plate surface 6. The plate body has a greater thickness 8 at the plate edge 7, which extends continuously around the plate surface 6, than in the region of the plate surface 6. This means that the plate surface 6 is recessed from the plate edge 7 in a plate stack direction 9 (see FIG. 4), which extends perpendicular to the longitudinal direction 2 and to the crosswise direction 4. In this manner, the plate edge 7 creates a filter chamber that is open to one side, with the plate surface 6 serving as a chamber tray.

In the exemplary embodiment, four support elements 10 are positioned on the plate surface 6, projecting outward from the plate surface 6 in the plate stack direction 9. In the completely assembled state, in which multiple chamber filter plates 1 are disposed side by side in the plate stack direction 9, the support elements 10 of two adjacent chamber filter plates 1 rest against one another, in order to stabilize the plate surfaces 6 against deformation by compression. In addition, a slurry or sludge feed borehole 11 that extends through the chamber filter plate 1 is disposed at the center of the plate surface 6. Filtrate discharge boreholes 12 extend through each corner region of the plate edge 7.

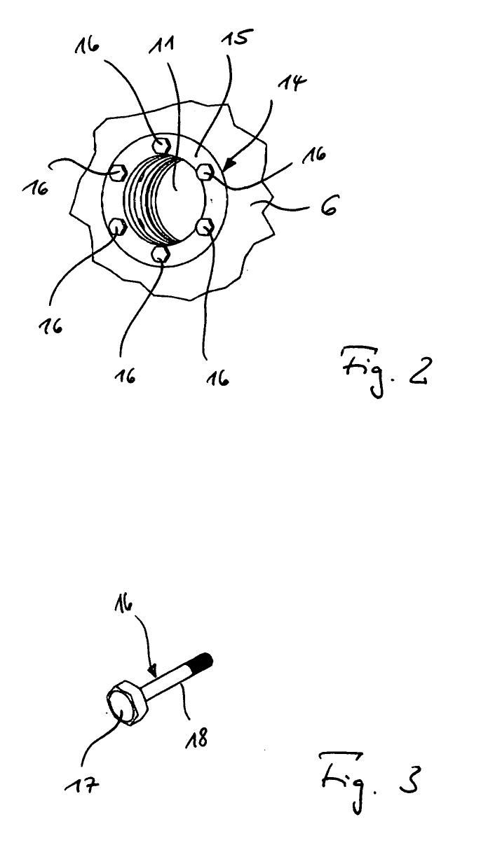

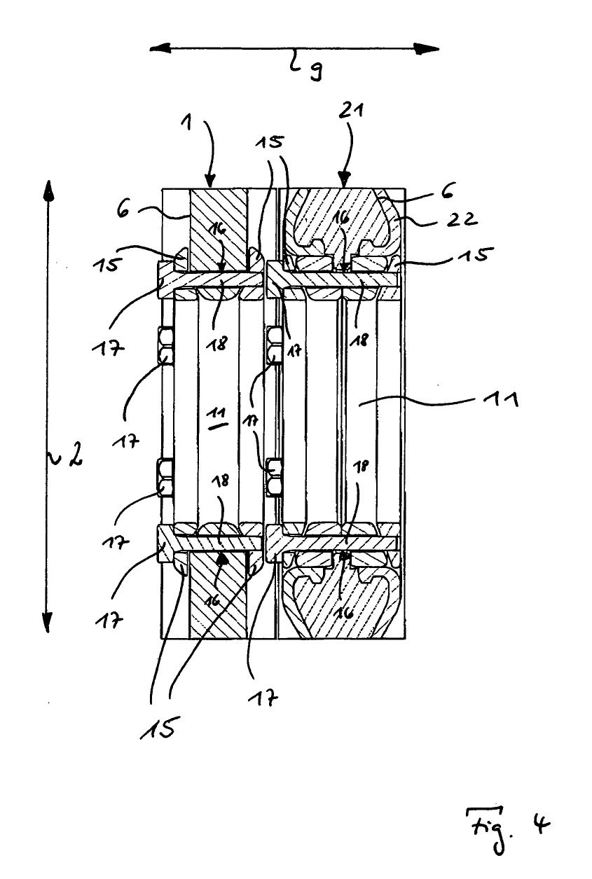

As is best seen in FIG. 2, a support ring 14 is disposed in the region of the slurry feed borehole 11. The support ring 14 flanks or borders the slurry feed borehole 11 and flanks or borders it with a circular, continuous mounting flange 15. The mounting flange 15, in the exemplary embodiment, is penetrated by six mounting screws 16. The mounting screws 16, as is seen in FIG. 3, have screw heads 17 that, in the final assembled position, rest against the plate surface 6 and project outward from the plate surface 6 in the plate stack direction 9. Finally, each of the mounting screws 16 has a shaft 18 that is equipped with threading. The shafts 18 of the mounting screws 16 extend through the body of the chamber filter plate 1.

The mode of operation is as follows:

A filter packet is formed of multiple chamber filter plates 1 disposed side by side in the plate stack direction 9. It is also possible for one chamber filter plate 1 and one membrane filter plate 21 to be disposed side by side, as is the case in the exemplary embodiment shown in FIG. 4. In this case, the filter plate shown on the right in FIG. 4 is a membrane filter plate 21. It differs from the chamber filter plate 1 disposed on the left in FIG. 4 in that a membrane 22 is placed on each side of the plate surface 6.

The shafts 18 of the mounting screws 16 each extend through the body of the chamber filter plate 1 and/or the membrane filter plate 21, and each holds a support ring 14 with a mounting flange 15 on each respective side of the chamber filter plate 1 and/or the membrane filter plate 21. In this way, the screw heads 17 of the mounting screws 16 project far enough from the plate surface 6 in the plate stack direction 9 that each screw head 17 rests with its upper surface that faces away from the plate surface 6 against the mounting flange 15 of the support ring of the filter plate 1, 21 that is adjacent in the plate stack direction 9. In this manner, the screw heads 17 associated with the membrane filter plate 21 shown on the right in FIG. 4 support the body of the membrane filter plate 21 against the support ring 14 of the chamber filter plate 1 that is adjacent toward the left. Thus, the screw heads 17 also serve as projecting elements or projections that act in the plate stack direction 9 to support the membrane filter plate 21 in the region of the slurry feed borehole 11.

1. A chamber filter plate for a filter press, the chamber filter plate comprising:
a plate surface having at least one slurry feed borehole formed therein defining an edge of said slurry feed borehole;
a plate edge being thicker than and extending around said plate surface;
a support ring encompassing said edge of said slurry feed borehole;
a mounting flange disposed on said support ring coplanar with said plate surface; and
at least three mounting cap screws distributed at equal angles about said mounting flange, extending through said mounting flange and fastening said support ring to said plate surface;
said at least three mounting cap screws each including a screw head acting as a projecting element having an end surface facing away from said plate surface with a flat area configured to be coplanar with a plate surface of an adjacent chamber filter plate.

2. The chamber filter plate according to claim 1, wherein said at least three mounting cap screws are three mounting cap screws mutually spaced apart by 120°.

3. The chamber filter plate according to claim 1, wherein said mounting flange has a width and said screw head has a diameter smaller than or equal to said width of said mounting flange.

4. The chamber filter plate according to claim 1, wherein said support ring is a metal ring.

5. The chamber filter plate according to claim 4, wherein said metal ring is a steel ring.

6. The chamber filter plate according to claim 1, wherein said slurry feed borehole is disposed at the center of said plate surface.

7. The chamber filter plate according to claim 1, which further comprises a membrane disposed on said plate surface.

8. A filter plate configuration, comprising:
at least two mutually adjacent chamber filter plates according to claim 1;
said screw heads, acting as projecting elements, resting against said support ring of a respective adjacent chamber filter plate, for supporting said support rings against one another.

9. The filter plate configuration according to claim 8, which further comprises a membrane disposed on one of said chamber filter plates forming a membrane filter plate, said membrane filter plate alternating side by side with a chamber filter plate without a membrane.
